(19) United States
(12) Patent Application Publication
(10) Pub. No.: US 2008/0123357 A1
(43) Pub. Date: May 29, 2008

(54) TAIL LIGHT ASSEMBLY FOR A MOTOR VEHICLE

(76) Inventors: Hans-Clemens Steffel, Stuttgart (DE); Filip Rosenstein, Stuttgart (DE); Bernd Mack, Remshalden (DE)

Correspondence Address: REISING, ETHINGTON, BARNES, KISSELLE, P.C., P O BOX 4390, TROY, MI, 48099-4390, US

(21) Appl. No.: 11/674,939

(22) Filed: Feb. 14, 2007

(30) Foreign Application Priority Data
Feb. 14, 2006 (DE) 10 2006 007 712.1

(51) Int. Cl. B60Q 1/00

(52) U.S. Cl. 362/487

(57) ABSTRACT

A tail light assembly for a motor vehicle includes a plurality of signal lights to signal various operations. Each of the plurality of signal lights includes segments of lights that are independently operable. A sensor system is electrically connected to the segments of lights for measuring an event and for creating a control signal in response to the occurrence of an event. The tail light assembly also includes a control module electrically connected between the segments of lights and the sensor system. The control module receives the control signal and operates each of the plurality of segments of lights to ensure each of the plurality of signal lights can operate to maximize visibility through a plurality of positions with respect to the motor vehicle. Brightness of the signal lights is seen in varying degrees of brightness, depending on the angle at which the viewer sees the tail light

### BACKGROUND ART

1. Field of the Invention

The invention relates to a light, in particular a tail light assembly for a motor vehicle. More particularly, the invention relates to a tail light assembly of a motor vehicle that produces light from two different light sources.

2. Description of the Related Art

Tail light assemblies of motor vehicles have the problem that when the tail light assembly is turned on, the signal lights are seen as varying in brightness, depending on the angle at which the viewer sees the rear light. The result may be that in one case the rear light blinds the driver of a following motor vehicle, whereas the driver of a motor vehicle located on the side and behind the vehicle does not notice the rear light or rather the corresponding signal light at all or notices it too late. Therefore, the signal function of the light is curtailed.

### SUMMARY OF THE INVENTION

A tail light assembly for a motor vehicle includes a plurality of signal lights to signal various operations of the motor vehicle. Each of the plurality of signal lights includes a plurality of segments of lights that are independently operable. A sensor system is electrically connected to each of the plurality of segments of lights for measuring an event and for creating a control signal in response to the occurrence of an event. The tail light assembly also includes a control module electrically connected between each of the plurality of segments of lights and the sensor system. The control module receives the control signal and operates each of the plurality of segments of lights to ensure each of the plurality of signal lights can operate to maximize visibility through a plurality of positions with respect to the motor vehicle.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a top view of a motor vehicle with a schematic depiction of light dispersion according to the invention;

FIG. 2 is a top view of a motor vehicle with a schematic depiction oof light dispersion in a functional range of a second motor vehicle;

FIG. 3 is a block diagram of the tail light assembly 2 assembly according to the invention; and

FIG. 4 is a circuit diagram of a drive circuit according to the invention.

### DETAILED DESCRIPTION OF THE PREFERRED EMBODIMENT

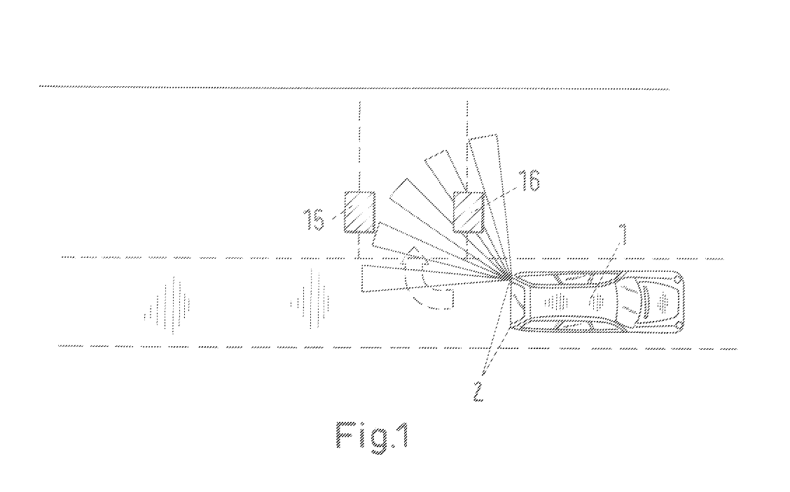

Referring to FIG. 1, a rear section of the motor vehicle 1 exhibits two tail light assembly 2, each of which exhibits at least one turn-signal light, a brake light and a rear light. In addition, the tail light assembly 2 may also exhibit a back-up light and/or a rear fog light. The tail light assembly 2 is designed in such a manner that they can be easily recognized by following road users irrespective of the viewing angle in relation to the tail, light assembly 2. The tail light, assembly 2 is designed in an advantageous manner so that they emit a constant brightness image in all directions.

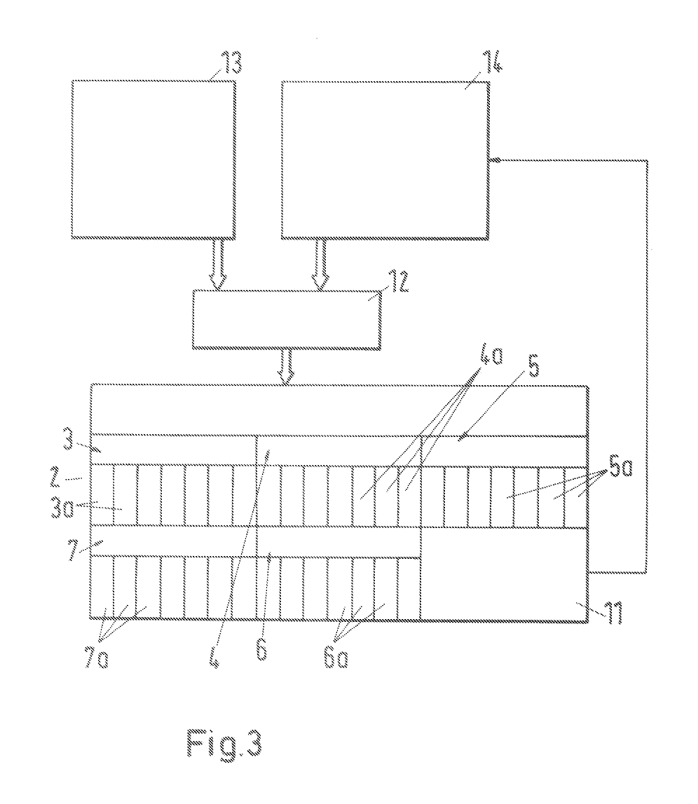

FIG. 3 is a schematic drawing of the tail light assembly 2, which exhibits a turn-signal light 3, a rear light 4, a rear fog light 5, a back-up headlight 6 and a brake light 7. In the illustrated embodiment these signal lights 3 to 7 consist of LED's, which are distinguished by their long service life. However, the signal lights 3 to 7 may also be formed by other types of light sources. The signal lights 3 to 7 are divided into individual segments 3a to 7a. If the signal lights 3 through 7 are formed by LED's, then it may be very easy to divide these signal lights 3 to 7 into segments. Therefore, each segment 3a to 7a may consist of at least one LED.

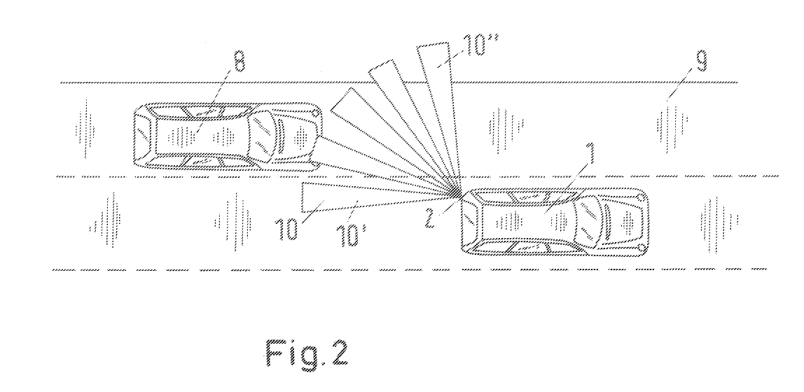

The individual segments 3a to 7a of the signal lights 3 to 7 are actuated independently of each other. Therefore, the individual segments 3a to 7a in each of the signal lights 3 to 7 may he actuated in such a manner that they emit light in varying degrees of brightness. For the brightness control of the segments 3a to 7a, it is advantageous to use a pulse width modulator. The brightness of the segments 3a to 7a is controlled in such a manner that, when looking at the rear side of the motor vehicle 1, the tail light assembly 2 emits a light of constant brightness irrespective of the viewing angle. Thus, it is guaranteed that following motor vehicles (one following motor vehicle 8 shown in FIG. 2), approaching the lead motor vehicle 1 from a number of different angles, are neither blinded nor recognize too late the light emitted by the tail light assembly 2. By way of example, FIG. 2 shows a following motor vehicle 8, which is located in a passing lane 9 and would like to pass the lead motor vehicle 1. The different viewing angles are represented schematically in FIG. 2 by triangles 10. The tail light assembly 2 emits the same brightness of light into each viewing direction. If the motor vehicle 8 is directly behind the motor vehicle 1, then the light intensity of the tail light assembly 2 is less than if the motor vehicle 8 is located in the passing lane 9. The light intensity is adjusted automatically. The triangles 10 indicate the beams of the corresponding signal light 3 to 7 that are emitted by the individual segments 3a to 7a. The segments 3a to 7a of each signal light 3 to 7 are tilted advantageously toward each other so that they emit the light in a number of different directions. The individual segments 3a to 7a that are emitted to the rear in the direction of travel of the motor vehicle 1 have a lower light intensity than the segments emitting light orthogonally to the rear. The segments 3a to 7a of each signal light 3 to 7 are actuated or energized correspondingly.

It is also possible to combine the individual segments 3a to 7a of at least one signal light, preferably of all signal lights 3 to 7, so as to form groups and to actuate the groups individually.

The individual segments 3a to 7a of each signal light 3 to 7 may be arranged side by side and/or one on top of the other. In addition, the individual segments 3a to 7a of the respective signal light 3 to 7 may exhibit the same length or different lengths.

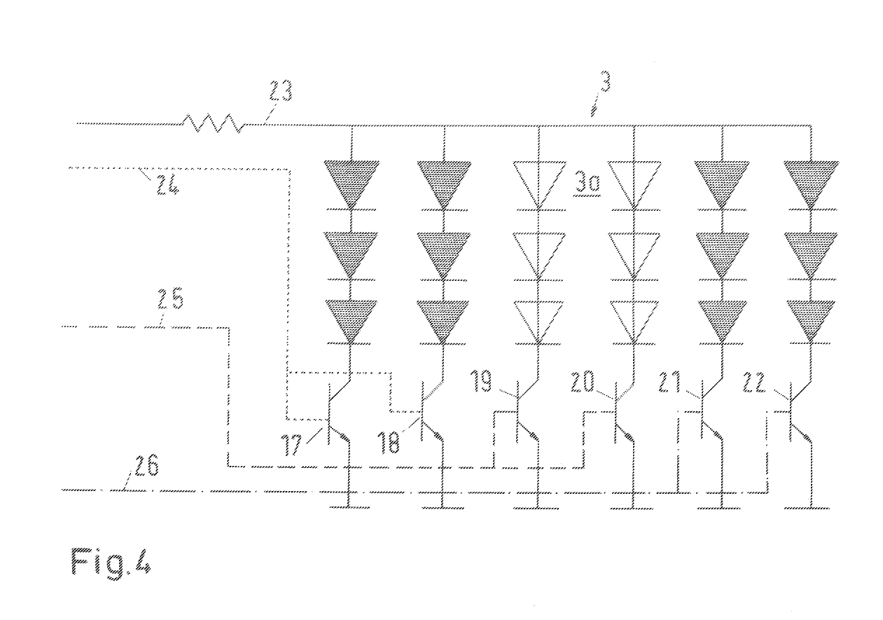

Referring to FIG. 4, an exemplary drive circuit is shown for the tail light assembly 2, or more specifically, one of its signal lights, for example the signal light 3. It includes, for example, six individual segments 3a of the tail light assembly 2, each of which exhibits three LED's. The individual segments 3a of the tail light assembly 2 are connected in parallel and attached to a common current-voltage line 23. Each individual segment 3a may be selected by means of a switch 17 to 22, which is preferably a transistor. In the embodiment, the individual segments 3a of the tail light assembly 2 are selected in pairs. However, it is also possible to select, each segment individually. And because in this embodiment the segments 3a of the tail light assembly 2 are selected in pairs, there are correspondingly three selection lines 24 to 26, with which two switches 17, 18; 19, 20; 21, 22 are always selected. If all three segment pairs are energized, the signal light 3 exhibits its maximum light intensity. In this case the switching signal is supplied over all three selection lines 24 to 26. However, it is also possible—depending on the traffic situation—to feed the corresponding switching signal to the corresponding switches by means of one selection line or two selection lines. If only one pair of segments is energized, the signal light 3 exhibits its lowest light intensity. Thus, the brightness of the signal light 3 may be adjusted specifically to the respective situation.

At the same time it is also possible to choose whether, for example, the right or the left or the two right or the two left pairs of segments shall be energized. Therefore, not only the brightness, but also the area to be illuminated is varied. All of the signal lights of the tail light assembly 2 may be energized in the manner described.

In order to detect the following motor vehicle 8 and determine its characteristic values, a sensor system 11 is housed in the tail light assembly 2 or in the motor vehicle 1. The sensor system 11 may exhibit, for example, a camera, which covers the area behind the motor vehicle 1. The image signals, generated by the camera, are sent as control signals to a control module 12, which evaluates these signals and transmits the corresponding control signals to the tail light assembly 2. In this way, the individual segments 3a to 7a are actuated in such a way that the light sources therein emit light of varying intensity. Thus, the individual segments 3a to 7a which are aimed toward the rear in the direction of travel, are not energized as much as those individual segments 3a to 7a that are aimed toward the side. In the drawing according to FIG. 2, the more the angle of radiation of the individual segments 3a to 7a deviates from the longitudinal axis of the vehicle the more of the individual segments 3a to 7a are irradiated. Thus, it is ensured that the tail light assembly 2 is energized in its segments in such a way that the brightness of the tail light assembly 2 is independent of the viewing angle of those the following motor vehicle 8.

The sensor system 11 may be provided with—instead of a camera—at least one environment sensor, a driver and motors, which detect and evaluate the traffic in the rear. As FIG. 3 shows, the sensor system 11 can also be used, for example, to gather data relating to the position of the respective object as well as also the data relating to the direction of this object. It is also possible, for example, to use the sensor system 11 to gather data relating to the speed of the object.

This data, determined by the sensor system 11, will still have to be linked to the data of the motor vehicle 1 in order to obtain a statement about the distance from the object behind the vehicle, whether said object is moving directly behind the motor vehicle 1 or diagonally thereto, whether the object is approaching in the direction of the motor vehicle 1 or maintaining a constant distance from said motor vehicle and the like. These vehicle-specific data 13 may be sent, for example, to the control module 12 via a CAN bus. The speed of the motor vehicle 1 can be acquired in a simple way, similarly its acceleration. The speed and the acceleration data are compared with the data relating to the speed and position of the object and determined by the sensor system 11.

From this comparison, one can derive whether the object located behind the motor vehicle 1 is moving, approaching or standing still. In addition, the control module 12 is fed data that determine the steering angle of the motor vehicle 1 and, for example, also the force, exerted on the brake pedal. From the steering angle one can derive whether the motor vehicle 1 is moving in a straight line or is cornering. From the braking force one can determine whether the vehicle is being stopped or slowed down. The determined brake force can also indicate the condition of the motor vehicle brakes.

In order to ascertain the rear and side traffic situation with the sensor system 11, other sensor technologies that are well-known per se may also be used. Suitable examples thereof are radar and ultrasonic systems, with which data about the traffic situation may be acquired just as reliably as with a camera.

By linking the vehicle-specific data 13 with the sensor-specific data 14 the tail light assembly 2 may be driven in such a manner that the brightness of the tail light assembly 2 always appears to be the same to all of the road users located in different directions and at different distances irrespective of their location. Thus, it is guaranteed that the tail light assembly 2 can be reliably recognized by the following road users. In particular, the road users are not blinded by the tail light assembly 2. The rear traffic can be monitored in the manner described.

FIG. 1 shows, as an example, a case, where the motor vehicle 1 is moving backwards into a yard driveway, a street or the like. With the tail light assembly 2 under discussion, objects 15, 16 that are located in the path of travel may be detected. In this respect these objects may be resting objects, but also, for example, pedestrians, bicyclists or the like. The sensor system 11 detects the objects 15, 16 and determines whether they change their position and/or their direction and/or their speed. Then the control module 12 receives the corresponding signals, which are linked with the specific data of the motor vehicle 1. In this way an especially bright beam of light can be sent, for example, to the area, in which the objects 15, 16 are located, so that they can be easily recognized by the driver of the motor vehicle 1. In this case the corresponding segments 6a of, for example, the back-up headlight 6, are energized more than those segments, of which the light source emits the light past the objects 15, 16.

A warning function of the tail light assembly 2 may also be achieved with the vehicle-specific data 13 and the sensor-specific data 14. Thus, for example, the driver of a following motor vehicle 8, which is approaching the lead vehicle 1 at a high speed, can be informed in time that the lead vehicle 1 is traveling at a significantly lower speed than the following motor vehicle 8. The sensor system 11 can determine with the gathered data relating to the position, direction and speed of the following motor vehicle 8 in connection with the vehicle-specific data 13, whether the following vehicle 8 is approaching the lead vehicle 1 very rapidly. Then the control module 12, which processes these data, may actuate, for example, both tail light assembly 2 simultaneously in such a way that the driver of the following motor vehicle 8 receives an early warning. Thus, it is possible, for example, for both tail light assembly 2 to emit light of maximum intensity to the rear or for the tail light assembly 2s to flash, for example, simultaneously or alternatingly. In this way, the attention of the driver of the following motor vehicle 8 is drawn unequivocally to the fact, that he is approaching the lead vehicle 1. This triggering of the warning function of the tail light assembly 2 is especially advantageous when the motor vehicle 1 is the last car at the end of a traffic jam and, thus, indicates in due time to the following motor vehicle 8 the last car at the end of the traffic jam. The warning function of the tail light assembly 2 is triggered automatically so that independently of the alertness of the driver in the motor vehicle 1, the following traffic is warned about the end car in the traffic jam.

So that the area on the side behind the motor vehicle 1 may be covered even better, other back-up light sources may be provided on the side of the motor vehicle. These back-up light sources emit their light predominantly or totally to the side. Then the critical side area will also be reliably illuminated.

In another embodiment the lights 3 to 7 or also their segments 3a to 7a are swivelled specifically by a swiveling mechanism. Thus, for example, it is possible to swivel the rear light 4 based on the data, relating to the position and direction of a following object and gathered by the sensor system 11, in such a way that the light emitted by the rear light 4 shines in the direction of this object. Moreover, just individual segments 4a of the rear light 4 may be swivelled in this direction. In this case the control module 12 actuates a motor of the swiveling mechanism in order to achieve the desired swiveling of the lighting means 3 to 7 or individual segments or a plurality of its segments 3a to 7a. Therefore, the swiveling may be carried out continuously so that the light, emitted by the respective lighting means, is emitted exactly in the desired direction. Especially when the vehicle 1 is cornering backwards, the back-up headlight 6 or one of its segments or a plurality of its segments 6a may be swivelled in such a way that the area, in which the vehicle is to be driven, is optimally illuminated.

The light rays may also be deflected by means of optical elements that are introduced into the beam path of the corresponding signal light 3 to 7. Depending on the direction in which the light beam has to be deflected, optical elements of varying shapes may be put into the beam path.

As described with reference to the embodiments, the brightness may be distributed either by means of the mechanical swiveling of the lights 3 to 7 or by switching on or by stepwise brightness variation of individual light segments 3a to 7a of a light function that are oriented to emit light in different directions, as also described above. In this way the area to be illuminated and the light intensity may be regulated simultaneously.

In order to carry out a swiveling procedure, it is possible, for example, to use an electric motor that is connected to the respective lighting means, an optical lens system located in front of the lighting means, or a reflector assigned to the lighting means. The electric motor is actuated to the desired degree as a function of the vehicle and sensor-specific data 13, 14. Owing to the variable cone of light as well as the environmental data gathered by the sensor system for the purpose of controlling the respective lighting means as a function of the other road users or the traffic events, the effect of the signal, the warning and the visibility is improved.

As evident from the described embodiments, not only the driver of his own motor vehicle is warned in a hazardous situation and, moreover, not just systems, such as airbags, to decrease such hazards are activated, but also the driver of the following motor vehicle is warned of a hazardous situation. Therefore, he has the chance to react early and, thus, to prevent, for example, an accident or at least to reduce its effects.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1-19. (canceled)

20. A tail light assembly for a motor vehicle, said tail light assembly comprising:
a plurality of signal lights to signal various operations of the motor vehicle;
each of said plurality of signal lights including a plurality of segments of lights independently operable;
a sensor system electrically connected to each of said plurality of segments of lights for measuring an event and for creating a control signal in response to the event occurring; and
a control module electrically connected between each of said plurality of segments of lights and said sensor system, said control module receiving the control signal and operating each of said plurality of segments of lights to ensure each of said plurality of signal lights can operate to maximize visibility through a plurality of positions with respect to the motor vehicle.

21. A tail light assembly as set forth in claim 20 wherein each of said plurality of segments of lights includes a plurality of individual lighting units.

22. A tail light assembly as set forth in claim 21 including a plurality of switches electrically connected between said control module and each of said plurality of segments of lights, each of said plurality of switches being controlled by said control module to operate each of said plurality of segments of lights.

23. A tail light assembly as set forth in claim 22 including a tail light lens disposed over said plurality of segments of lights to focus light emitted thereby.

24. A tail light assembly as set forth in claim 23 wherein said tail light lens moves with respect to said plurality of segments of lights to direct the light emitted thereby.

25. A tail light assembly as set forth in claim 23 wherein each of said plurality of segments of lights moves with respect to said tail light lens to direct the light emitted thereby.
